(19) United States
(12) Patent Application Publication
(10) Pub. No.: US 2025/0052497 A1
(43) Pub. Date: Feb. 13, 2025

(54) Arrangement for Heating a Process Gas of an Iron Ore Pelletizing Plant

(71) Applicant: HYBRIT Development AB, Stockholm (SE)

(72) Inventor: Christian Fredriksson, Luleå (SE)

(21) Appl. No.: 18/719,633

(22) PCT Filed: Feb. 15, 2023
(86) PCT No.: PCT/SE2023/050128

§ 371 Date: Jun. 13, 2024

(30) Foreign Application Priority Data
Feb. 17, 2022 (SE) 2250162-1

(51) Int. Cl. F27B 9/36; C22B 1/02; C22B 1/24; F23C 9/00; F23D 14/22; F23D 14/58

(52) U.S. Cl. CPC F27B 9/36; C22B 1/02; C22B 1/2406; F23C 9/00; F23D 14/22; F23D 14/58; F23C 2900/9901

(57) ABSTRACT

An arrangement for heating a process gas of an iron ore pelletizing plant, including a heating chamber including a gas inlet, a gas outlet, a wall extending from the gas inlet to the gas outlet, and a heating chamber port arranged in the wall at a point intermediate to the process gas inlet and the process gas outlet, a burner assembly connectible to a source of gaseous fuel and a source of oxidant gas, and a precombustion chamber. The precombustion chamber includes a burner port and a wall extending from the burner port to the heating chamber port. The burner assembly is arranged in the burner port of the precombustion chamber and, in operation, the burner assembly introduces the gaseous fuel, the oxidant gas and/or combustion products thereof into the precombustion chamber. The burner assembly includes a fuel lance, wherein a nozzle of the fuel lance includes outlet holes, and wherein at least one of the outlet holes is arranged at an angle relative to a longitudinal axis of the fuel lance.

### TECHNICAL FIELD

The present disclosure relates to an arrangement for heating a process gas of an iron ore pelletizing plant, a pelletizing plant for iron ore comprising such an arrangement, and a method for heating a process gas in such a pelletizing plant.

### BACKGROUND ART

Steel is the world's most important engineering and construction material. It is difficult to find any object in the modern world that does not contain steel, or depend on steel for its manufacture and/or transport. In this manner, steel is intricately involved in almost every aspect of our modern lives.

Although steelmaking processes have been refined over decades and are approaching the theoretical minimum energy consumption, there is at least one fundamental issue that has not yet been resolved. The steel industry is one of the highest CO₂-emitting industries, accounting for approximately 7% of CO₂ emissions globally. For every ton steel produced in 2018, an average of 1.83 tonnes of CO₂ were produced.

The HYBRIT initiative has been founded to address this issue. HYBRIT, short for HYdrogen BReakthrough Ironmaking Technology, aims to reduce CO₂ emissions and de-carbonize the steel industry throughout the entire production chain, from mining ore to finished steel product.

Newly mined iron ore is typically processed by sorting, concentrating and pelletizing prior to its use in a steelmaking process, in order to ensure a feed that has reliably excellent chemical and mechanical properties. Pellets may typically be formed by the steps of adding a binder to the iron ore concentrate, rolling “green” pellets, drying, sintering and cooling. The pelletizing process involves heating the pellets to temperatures in excess of 1000° C., and this is typically done in direct-fired furnaces wherein one or more burners are used to heat the pelletizing process air. Such burners typically operate using fossil fuels such as heavy fuel oil or natural gas, although full-scale trials using bio oil are ongoing at an LKAB pelletizing plant in order to decrease net CO2 emissions.

There remains a need for more environmentally benign means for producing iron ore pellets.

### SUMMARY OF THE INVENTION

The use of hydrogen as a burner fuel in heating the pelletizing process has the potential to decrease CO₂ emissions associated with pellet production. Hydrogen may be produced by electrolysis of water using mainly fossil-free and/or renewable primary energy sources, as is the case for e.g., Swedish electricity production. Thus, the heating of the pellet furnace may be achieved without requiring fossil fuel as an input, and with water as the combustion by-product instead of CO₂. However, using hydrogen as the burner fuel brings its own challenges. The inventors of the present invention have found that burning hydrogen to heat the pellet furnace may risk excessive NOx formation. If it is not possible to decrease the NOx formed when burning hydrogen, this would necessitate implementation of expensive NOx emission reduction technologies as an after-treatment of spent process gas.

It would be advantageous to achieve a means of overcoming, or at least alleviating, at least some of the above mentioned drawbacks. In particular, it would be desirable to enable a means for heating the process gas of an iron ore pelletizing plant that avoids CO₂ emissions but does not lead to an excessive increase in NOx formation. To better address one or more of these concerns, an arrangement having the features defined in the independent claim is provided.

The arrangement comprises:
a heating chamber comprising a process gas inlet, a process gas outlet, a wall extending from the process gas inlet to the process gas outlet, and a heating chamber port arranged in the wall at a point intermediate to the process gas inlet and the process gas outlet; and
a burner assembly arranged to be connectible to a source of gaseous fuel and a to source of oxidant gas.

The arrangement further comprises a precombustion chamber. The precombustion chamber comprises a burner port and a wall extending from the burner port to the heating chamber port. The burner assembly is arranged in the burner port of the precombustion chamber. When in operation, the burner assembly is arranged to introduce the gaseous fuel, the oxidant gas and/or combustion products thereof into the precombustion chamber. The burner assembly comprises a fuel lance. A nozzle of the fuel lance comprises a plurality of outlet holes. At least one of the plurality of outlet holes is arranged at an angle relative to a longitudinal axis of the fuel lance.

It has been found that when using hydrogen as the gaseous fuel, use of an arrangement comprising both a precombustion chamber and a fuel lance nozzle having angled outlet holes as disclosed herein leads to comparatively low levels of NOx formation. This is unexpected since, as demonstrated herein, neither use of a precombustion chamber nor use of a fuel lance nozzle having angled outlet holes individually lead to any noteworthy decrease in NOx as compared to a suitable reference case lacking both of these features. Thus, the combination of both a precombustion chamber and a fuel lance nozzle having angled outlet holes demonstrates a synergistic effect that cannot be predicted from observation of each of the features in isolation.

According to a second aspect there is provided a pelletizing plant for iron ore, comprising an arrangement according to the first aspect.

According to a third aspect there is provided a method for heating a process gas in a pelletizing plant according to the second aspect. The method comprises the steps:
supplying a process gas to the process gas inlet; and
supplying hydrogen gas and oxidant gas to the burner assembly, thereby introducing the hydrogen gas and oxidant gas into the precombustion chamber, where they react by combustion at least partially and are conveyed into the heating chamber, thereby heating the process gas.

Further objects, advantages and novel features of the present invention will become apparent to one skilled in the art from the following detailed description. The detailed description and specific examples disclose preferred embodiments of the disclosure by way of illustration only. Those skilled in the art understand from guidance in the detailed description that changes and modifications may be made within the scope of the disclosure.

### BRIEF DESCRIPTION OF THE DRAWINGS

For a fuller understanding of the present invention and further objects and advantages of it, the detailed description set out below should be read together with the accompanying drawings, in which the same reference notations denote similar items in the various diagrams, and in which:

FIG. 1 schematically illustrates an exemplifying embodiment of an arrangement for heating a process gas of an iron ore pelletizing plant;

FIGS. 2a-f schematically illustrate exemplifying embodiments of nozzles that may be attached to the fuel lance;

FIG. 3 schematically illustrates an exemplifying embodiment of a pelletizing plant for iron ore;

FIG. 4 schematically illustrates a cross sectional view of a firing zone of a pelletizing plant;

FIG. 5 is a flowchart illustrating a method for heating a process gas in a pelletizing plant; and

FIG. 6 is a chart showing measured NOx emissions for a variety of setups as determined in experimental trials.

### DETAILED DESCRIPTION

The invention will now be described in more detail with reference to certain exemplifying embodiments and the drawings. However, the invention is not limited to the exemplifying embodiments discussed herein and/or shown in the drawings, but may be varied within the scope of the appended claims. Furthermore, the drawings shall not be considered drawn to scale as some features may be exaggerated in order to more clearly illustrate certain features.

It is to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not necessarily exclude other elements or steps, although the term “comprising” may also encompass the terms “consisting essentially of” and “consisting of” in instances where such an interpretation is technically reasonable.

Arrangement for heating a process gas.

According to a first aspect there is provided an arrangement for heating a process gas of an iron ore pelletizing plant. The arrangement comprises:
a heating chamber comprising a process gas inlet, a process gas outlet, a wall extending from the process gas inlet to the process gas outlet (thereby defining a heater chamber volume), and a heating chamber port arranged in the wall at a point intermediate to the process gas inlet and the process gas outlet (the port thereby providing access to the heater chamber volume);
a precombustion chamber comprising a burner port and a wall extending from the burner port to the heating chamber port (thereby defining a precombustion chamber volume); and
a burner assembly arranged to be connectible to a source of gaseous fuel and a to source of oxidant gas.

The burner assembly is arranged in the burner port of the precombustion chamber. The burner assembly is arranged to introduce the gaseous fuel, the oxidant gas and/or combustion products thereof into the precombustion chamber (i.e., into the precombustion chamber volume) when in operation. The burner assembly comprises a fuel lance. A nozzle of the fuel lance comprises a plurality of outlet holes. At least one of the plurality of outlet holes is arranged at an angle relative to a longitudinal axis of the fuel lance.

As previously stated, it has been found that use of such an arrangement when using hydrogen as the gaseous fuel leads to unexpectedly high suppression of NOx formation (hereinafter “Nox suppression”), and the combination of both a precombustion chamber and a fuel lance nozzle having angled outlet holes demonstrates a synergistic effect on Nox suppression. This Nox suppression effect may also be obtained using gaseous fuels other than hydrogen. However, since other gaseous fuels, such as natural gas, typically burn with a lower flame temperature as compared to hydrogen, the problem of excess Nox formation is not typically as pronounced with such fuels, depending on the fuel composition.

By “arranged at an angle relative to a longitudinal axis of the fuel lance”, it is meant that a centerline of the relevant outlet hole forms a non-zero angle with respect to the longitudinal axis of the fuel lance, i.e., an angle greater than zero degrees and less than 180 degrees. Due to the arrangement of the burner assembly in the burner port, the longitudinal axis of the fuel lance essentially corresponds to the longitudinal axis of the precombustion chamber. This means that the relevant outlet hole also forms a corresponding angle with respect to the longitudinal axis of the precombustion chamber.

Each of the plurality of outlet holes may be arranged at an angle relative to the longitudinal axis of the fuel lance, i.e., all outlet holes are angled. Such embodiments have been found to provide excellent NOx suppression in both experimental and computational studies. Alternatively, a proportion of the plurality of outlet holes may be arranged at an angle relative to the longitudinal axis of the fuel lance, and the remaining proportion may be non-angled, i.e., have a centerline corresponding or parallel to the longitudinal axis of the fuel lance. Computational studies have demonstrated that such embodiments are expected to provide NOx suppression comparable to embodiments where all outlet holes are angled. If all outlet holes are arranged at an angle, all outlet holes may have the same angle relative to the longitudinal axis of the fuel lance, or they may have different angles. For example, a proportion of the plurality of outlet holes may be arranged at a first angle relative to the longitudinal axis of the fuel lance, and the remaining proportion may be arranged at a second angle.

If arranged at an angle relative to the longitudinal axis of the fuel lance, an outlet hole may be arranged at an angle of greater than about 1° and less than about 90°, such as from about 30° to about 60°, such as from about 40° to about 50°, such as about 45° for example, each of the plurality of outlet holes may be arranged at an angle of 30° or greater relative to the longitudinal axis of the fuel lance, and/or each of the plurality of outlet holes may be arranged at an angle of 45° or less relative to the longitudinal axis of the fuel lance. The outlet holes should be suitably angled in order to obtain an adequate degree of Nox suppression.

The nozzle should comprise an adequate number and size of outlet holes in order to provide a suitable fuel outlet velocity and pressure drop during operation. The nozzle may comprise at least three outlet holes. The number of outlet holes may for example range from about three to about 40, such as from about six to about 30. The diameter of each outlet hole may independently be from about 3 mm to about 10 mm. All outlet holes may have the same diameter, or they may have different diameters. For example, a proportion of the plurality of outlet holes may have a first diameter, and the remaining proportion may have a second diameter.

Although the arrangement is described in the exemplifying embodiments as disclosed herein as comprising a single process gas inlet, a single process gas outlet and a single burner assembly, the arrangement may comprise multiple such inlets, outlets and/or assemblies.

The arrangement may be configured such that the burner port, precombustion chamber, heating chamber port, and process gas outlet share a common centerline/longitudinal axis.

For example, the precombustion chamber together with a section of the heating chamber extending from the heating chamber port to the process gas outlet may be composed of a single length of piping extending from the burner port to the process gas outlet.

The section of the heating chamber extending from the process gas inlet may be configured such that this section and the process gas inlet share a common centerline/longitudinal axis, and this centerline/longitudinal axis may be configured perpendicular to the centerline/longitudinal axis extending from the burner port to the process gas outlet, such that the perpendicular axes meet at a point intermediate the heater chamber port and process gas outlet. In other words, the arrangement may have an inverted “T” shape.

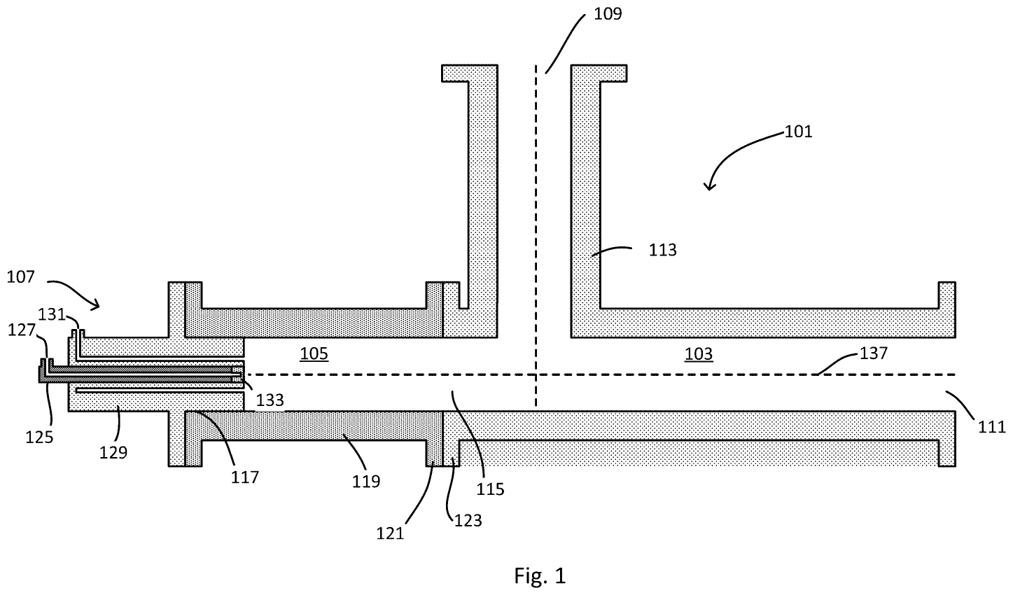

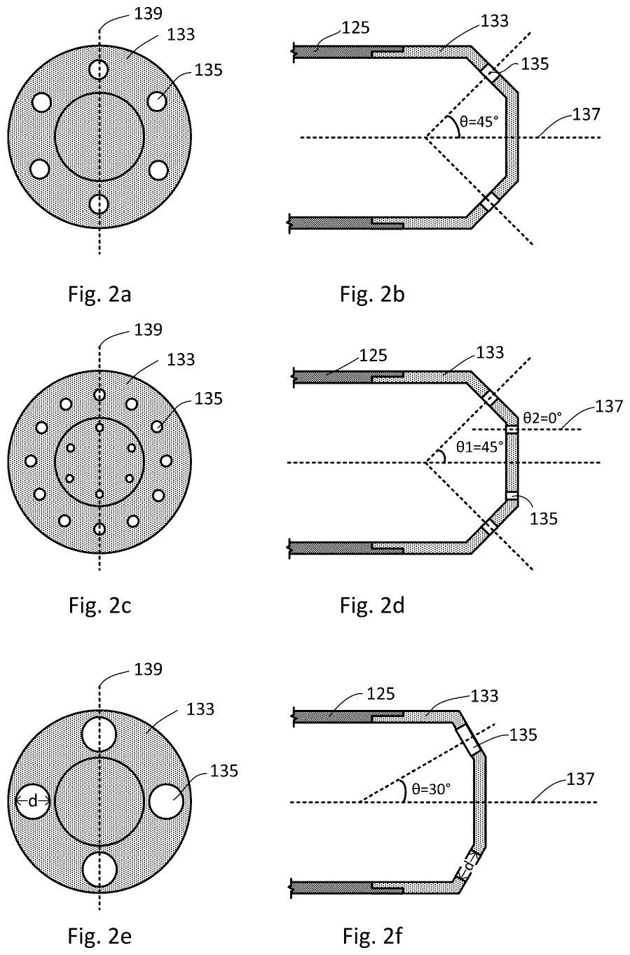

FIG. 1 schematically illustrates an exemplifying embodiment of an arrangement for heating a process gas of an iron ore pelletizing plant according to the present disclosure. The arrangement 101 comprises a heating chamber 103, a precombustion chamber 105 and burner assembly 107. The heating chamber comprises a process gas inlet 109, a process gas outlet 111, a wall 113 extending from the process gas inlet to the process gas outlet, and a heating chamber port 115 arranged in the wall at a point intermediate to the process gas inlet 109 and the process gas outlet 111. The precombustion chamber 105 comprises a burner port 117 and a wall 119 extending from the burner port 117 to the heating chamber port 115. In the presently illustrated embodiment, the heating chamber 103 and precombustion chamber are illustrated as discrete components fixedly attached by flanges 121 and 123. However, the heating chamber 103 and precombustion chamber may readily be manufactured as a single component. The burner assembly 107 is arranged in the burner port of the precombustion chamber and comprises a fuel lance 125 and a gas register 129. The gas register 129 comprises an oxidant gas inlet 131 to be connected to a source of oxidant gas. The fuel lance 125 comprises a fuel inlet 127 to be connected to a source of gaseous fuel. A nozzle 133 of the fuel lance 125 comprises a plurality of outlet holes 135, as illustrated in FIGS. 2a-2f. As will be seen from these figures, at least one of the plurality of outlet holes is arranged at an angle @ relative to a longitudinal axis 137 of the fuel lance. When in operation, the burner assembly 107 is arranged to introduce the gaseous fuel, the oxidant gas and/or combustion products thereof into the precombustion chamber 105.

FIGS. 2a-f schematically illustrate a variety of nozzles 133 which may be attached to the fuel lance 125. FIGS. 2a, 2c and 2e illustrate each nozzle 133 in frontal view, and FIGS. 2b, 2d and 2f illustrate the corresponding nozzle 133 in a cross-sectional view in the plane as defined by line 139. Each nozzle 133 comprises a plurality of outlet holes 135, each outlet hole 135 having a diameter d. As illustrated in the figures, at least one of the plurality of outlet holes 135 is arranged at an angle θ relative to a longitudinal axis 137 of the fuel lance 125.

The nozzle 133 illustrated in FIGS. 2a and 2b has a total of six outlet holes 135, each of the outlet holes having an angle θ=45° relative to a longitudinal axis 137 of the fuel lance 125.

The nozzle 133 illustrated in FIGS. 2c and 2d has a total of 18 outlet holes 135, twelve of which have an angle θ=45° relative to a longitudinal axis 137 of the fuel lance 125, and six of which are not angled relative to the longitudinal axis 137 of the fuel lance 125, i.e., θ=0°. The non-angled outlet holes 135 have a smaller diameter d relative to the angled outlet holes 135.

The nozzle 133 illustrated in FIGS. 2e and 2f has a total of four outlet holes 135, each of the outlet holes having an angle θ=30° relative to a longitudinal axis 137 of the fuel lance 125. The outlet holes 135 of this nozzle 133 have a diameter d that that is larger than the outlet hole diameters d of the other illustrated embodiments.

### Pelletizing Plant

According to a second aspect there is provided a pelletizing plant for iron ore, comprising an arrangement according to the first aspect. By utilizing one or more arrangements as disclosed herein to heat the process gas of the pelletizing plant, this enables production of iron ore pellets with low emission of NOx, and with lesser or no need for emissions aftertreatment to remove NOx from the spent process gases.

The pelletizing plant may be a straight grate pelletizing plant. In such a case, the process gas outlet may be arranged in connection with a firing zone of the pelletizing plant. The arrangement as described herein is readily applicable to a straight grate system, and the experimental studies described herein are performed on a system modelling a burner port of a typical full-scale straight grate plant. Alternatively, the pelletizing plant may utilize an alternative pellet production system.

The burner assembly may be arranged in connection with a source of hydrogen gas as a source of gaseous fuel. The hydrogen gas may be derived from a non-fossil source, such as electrolytic hydrogen produced using fossil-free and optionally renewable electricity. Thus, production of pellets with low CO₂ and NOx emissions is enabled.

The burner assembly may be arranged in connection with a further source of gaseous fuel, such as natural gas or biomethane. The composition of the fuel to the burner assembly may for example comprise, consist essentially of, or consist of, a preset or variable blend of hydrogen and another gaseous fuel.

According to some embodiments, the burner assembly is arranged in connection with a recycled process gas stream as the source of oxidant gas. This helps avoid the need to heat excessive volumes of process air and assists in improving the energy-effectivity of the plant. Alternatively, the burner assembly may be arranged to utilize ambient air as the source of oxidant gas, for example assisted by a compressor to supply air as oxidant gas. The use of cold oxidant gas may further decrease NOx formation, however at the expense of somewhat increased energy consumption.

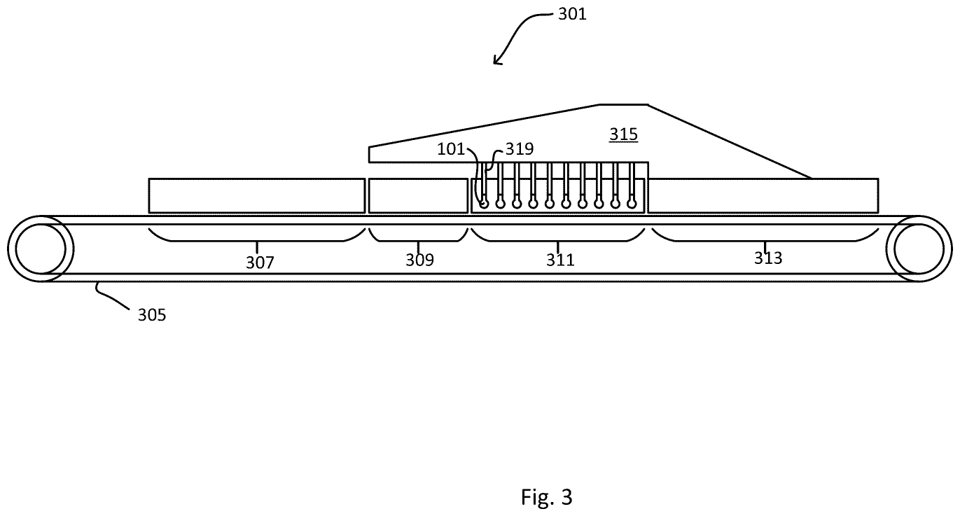

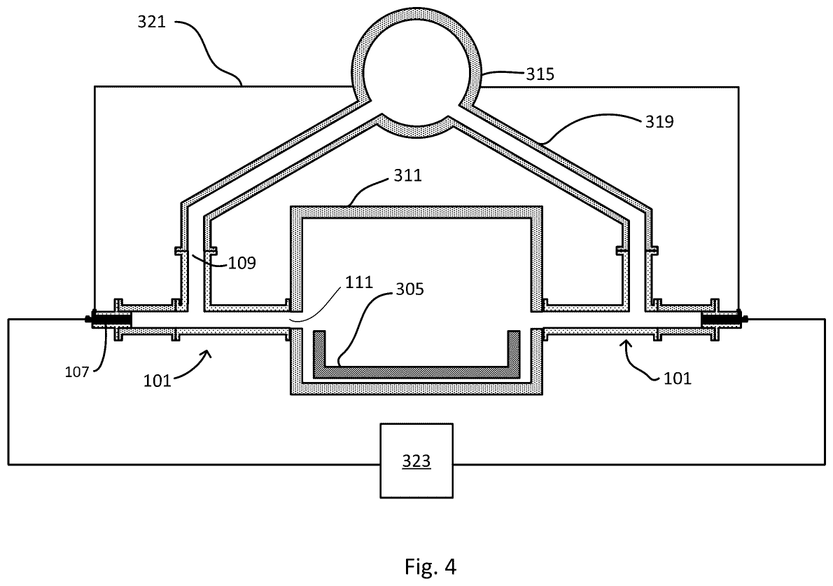

FIG. 3 schematically illustrates an exemplifying embodiment of a pelletizing plant for iron ore according to the present disclosure. The illustrated pelletizing plant 301 is of the straight-grate type and comprises a travelling grate 305 arranged to convey pellets through the following zones sequentially: the drying zone 307, preheating zone 309, firing zone 311, and cooling zone 313. It is known in the art to have more or fewer zones. For example, the drying zone 307 may comprise an updraft drying zone and a downdraft drying zone; and/or an after-firing zone may be arranged sequentially after the firing zone 311 prior to the cooling zone 313. A process gas recycle duct 315 is arranged in connection with the cooling zone 313 to recycle used process gas to other zones in the plant. A series of arrangements 101 for heating the process gas are configured in conjunction with the firing zone 311. FIG. 4 schematically illustrates a cross sectional view of the firing zone 311 with arrangements 101. A downcomer pipe 319 is arranged in conjunction with each arrangement to lead recycled process gas from the process gas recycle duct 315 to the process gas inlet 109 of the arrangement 101. A source of gaseous fuel 323, such as hydrogen gas, is arranged to provide the burner assemblies 107 with gaseous fuel. The burner assemblies are also provided with a source of oxidant gas, herein illustrated as line 321 providing recycled process gas from the process gas recycle duct 315 to the burner assemblies 107. Note that in other embodiments, the oxidant gas may be taken from elsewhere in the plant. The process gas outlet 111 of the arrangement 101 is arranged in connection with the firing zone 311 of the pelletizing plant 301, such that pellets (not illustrated) arranged on the travelling grate 305 are sintered by the process gases heated using the burner arrangements 107.

### Method

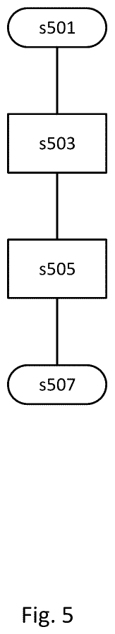

According to a third aspect there is provided a method for heating a process gas in a pelletizing plant according to the second aspect. The method is illustrated in FIG. 5 and comprises the following steps. Step s501 denotes the start of the process. In step s503, a process gas is supplied to the process gas inlet. In step s505, gaseous fuel and oxidant gas are supplied to the burner assembly. The gaseous fuel and oxidant gas are thereby introduced into the precombustion chamber, where they react by combustion at least partially and are conveyed into the heating chamber, thereby heating the process gas. Step s507 denotes the end of the process.

The advantages associated with such a process are as previously described in relation to the pelletizing plant.

The gaseous fuel may consist essentially of hydrogen, or consist of hydrogen. This provides a pelletizing process having low CO₂ and NOx emissions. Alternatively, the gaseous fuel may comprise or consist essentially of a preset or variable blend of hydrogen and an alternative gaseous fuel, such as natural gas or biomethane. In the pelletizing plant 301, some burner assemblies 107 may be supplied with hydrogen, whereas other burner assemblies 107 may be supplied with an alternative gaseous fuel or gaseous fuel blend.

The process gas and/or the oxidant gas may independently be composed essentially of recycled process gas streams. The oxidant gas supplied to the burner assembly may have a temperature greater than 300° C. The process gas supplied to the process gas inlet may have a temperature greater than 900° C. Use of recycled and/or preheated gas streams decreases the energy requirements for heating the process gas to the desired temperature, thereby providing greater overall process effectivity.

Oxidant gas and hydrogen gas may be supplied to the burner assembly to achieve an air-fuel equivalence ratio (A) of from about greater than 0.6 to about less than 1, such as from about 0.7 to about 0.95, such as from about 0.8 to about 0.9. Such “rich” mixtures have been found to provide enhanced NOx suppression. Without wishing to be bound by theory, it is thought that this allows combustion of the gaseous fuel to be distributed between the precombustion and heating chambers, thus avoiding excessive localized heat generation and in this manner avoiding NOx formation. The air-fuel equivalence ratio (A) is determined by standard means known in the art.

Oxidant gas and hydrogen gas may be supplied to the burner assembly to achieve a process gas temperature at the process gas outlet of greater than 1100° C., such as greater than 1200° C.

Oxidant gas may be supplied to the burner assembly in order to achieve a volumetric flow ratio of process gas: oxidant gas of from about 5:1 to about 20:1, measured as the flow of process gas flowing through the process gas inlet relative to the flow of oxidant gas supplied through the burner arrangement.

The person skilled in the art realizes that the present disclosure is not limited to the preferred embodiments described above. The person skilled in the art further realizes that modifications and variations are possible within the scope of the appended claims. For example, the heating chamber and precombustion chamber are not necessarily separate components, and may be manufactured as a whole. Additionally, variations to the disclosed embodiments can be understood and effected by the skilled person in practicing the claimed disclosure, from a study of the drawings, the disclosure, and the appended claims.

### EXPERIMENTAL

Pilot scale trials have been performed at the Experimental Combustion Furnace (ECF) test facility in the premises of Swerim AB, Luleå, Sweden. In brief, the ECF facility as used in the trials comprised a single pilot-scale burner arrangement and heating chamber, with a downcomer pipe attached to the process gas inlet of the heating chamber and the process gas outlet opening out to the furnace body of the test facility. The test facility is equipped with a variety of sensors in order to measure e.g., temperature and gas composition at a variety of points in the furnace and flue gas outlet.

Trials have been performed both with a precombustion chamber mounted to the heating chamber port, or with the burner assembly mounted directly in the heating chamber port (i.e., with no precombustion chamber). Trials have been performed using a variety of nozzles on the fuel lance. The following nozzles have been tested:

| Nozzle name | Construction |
|---|---|
| Standard | Nozzle with two concentric rings of 12 outlet |
| | holes in each ring. The outer ring has a |
| | diameter of 22.5 mm and the inner ring has a |
| | diameter of 13 mm. The 12 outlet holes in the |
| | outer ring have a diameter of 4.5 mm each, |
| | and the 12 outlet holes in the inner ring have a |
| | diameter of 2.5 mm each. The outlet holes are |
| | non-angled (holes parallel with axis of lance). |
| 45° - 6*4 mm | Nozzle with single ring of 6 holes, each hole |
| | having 4 mm diameter. Each of the holes are |
| | angled 45° relative to the central axis of the |
| | nozzle. Similar to the nozzle illustrated in |
| | FIGS. 2a and 2b. |
| 45° - 6*9 mm | Nozzle with single ring of 6 holes, each hole |
| | having 9 mm diameter. Each of the holes are |
| | angled 45° relative to the central axis of the |
| | nozzle. Similar to the nozzle illustrated in |
| | FIGS. 2a and 2b. |
| 45° - 30*4 mm | Nozzle with two concentric rings with a total of |
| | 30 holes distributed between the rings. Each |
| | hole has 4 mm diameter. Each of the holes are |
| | angled 45° relative to the central axis of the |
| | nozzle. Similar to the nozzle illustrated in |
| | FIGS. 2a and 2b, but with a double ring of holes. |

Hydrogen gas (113 Nm³/h, 20° C.) is used as the fuel in all trials, and air is used as the oxidant gas, where applicable (see below). Air (2180 Nm³/h) is also used as the downcomer gas flow, preheated to a temperature of approx. 950° C. in order to approximate a recycled process gas stream.

In trials lacking a precombustion chamber, trials were performed with no oxidant gas supplied to the burner arrangement, or with 200 Nm³/h oxidant gas supplied to the burner arrangement. Where no oxidant gas was supplied, the gas register of the burner arrangement was replaced by a ceramic plug. The oxidant gas supplied in these trials was at ambient temperature (approx. 20° C.).

In trials with a precombustion chamber, an oxidant gas flow of approx. 230 Nm³/h preheated to a temperature of approx. 400° C. was used in order to approximate a recycled process gas stream.

The following trials were performed:

| | | | Oxidant gas | | |
|---|---|---|---|---|---|
| Trial | Precombustion | Oxidant gas | temperature | | |
| no. | chamber | flow (Nm³/h) | (° C.) | Nozzle | |
| 1 | No | 0 | — | Standard | |
| 2 | No | 0 | — | 45° - 6*4 | mm |
| 3 | No | 0 | — | 45° - 6*9 | mm |
| 4 | No | 0 | — | 45° - 30*4 | mm |
| 5 | No | 200 | 20 | Standard | |
| 6 | No | 200 | 20 | 45° - 6*4 | mm |
| 7 | Yes | 230 | 400 | Standard | |
| 8 | Yes | 230 | 400 | 45° - 6*4 | mm |
| 9 | Yes | 230 | 400 | 45° - 6*9 | mm |
| 10 | Yes | 230 | 400 | 45° - 30*4 | mm |

Similar flue gas temperatures (1200-1300° C.) were obtained in all trials. However, the flue gas temperatures obtained in trials using cold oxidant gas (trials 5-6) were somewhat lower as compared to the other trials due to the large amounts of cold gas being heated.

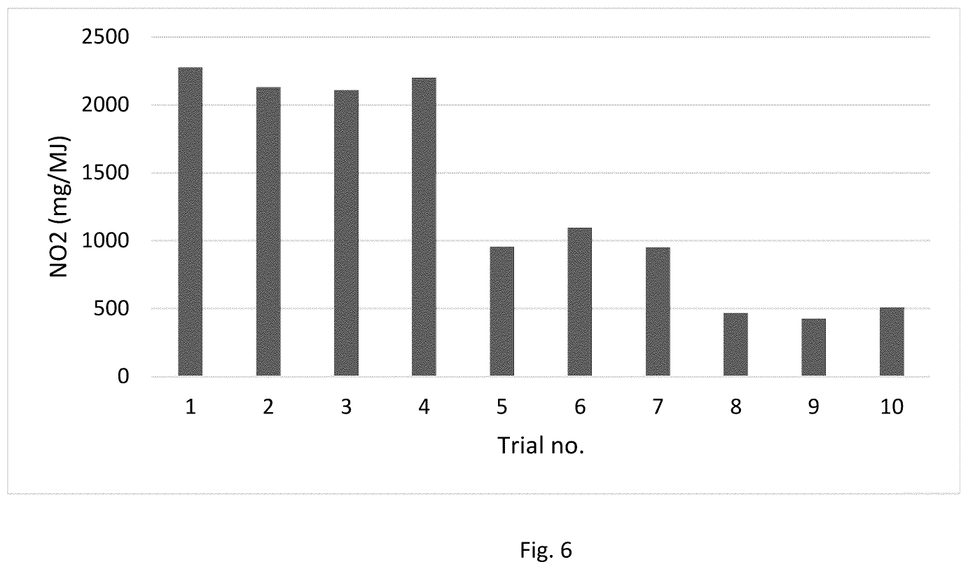

The measured NOx emissions obtained in the trials is shown in the chart of FIG. 6.

It can be seen that for the trials lacking a precombustion chamber and with no supplied oxidant gas (Trials 1-4), the obtained NOx emissions are very high (>2000 mg/MJ). The observed effect of swapping the standard nozzle for a nozzle with angled holes in these trials is marginal.

Somewhat improved NOx levels (approx. 1000 mg/MJ) are obtained in trials with supplied oxidant gas, but no precombustion chamber (Trials 5-6). However, the NOx levels obtained are still not satisfactory. Swapping the standard nozzle for a nozzle with angled holes in these trials resulted in slightly increased NOx levels (compare Trials 5 and 6).

In trials with a precombustion chamber, use of a standard nozzle was found to provide NOx levels in line with those obtained without the precombustion chamber (compare e.g., Trials 5 and 7). That is to say that use of a precombustion chamber alone was not found to have any significant effect on NOx levels. However, use of a precombustion chamber in combination with a nozzle with angled holes was found to lead to substantial decreases in NOx (Trials 8-10). The obtained NOx levels are less than approx. 500 mg/MJ.

Thus, to summarize, trials using no precombustion chamber and no angled nozzle (trial 5), trials using an angled nozzle only (trial 6) and trials using a precombustion chamber only (trial 7) were all found to provide approximately equal levels of NOx (approx. 1000 mg/MJ), all of which were unsatisfactory. However, the combination of precombustion chamber together with angled nozzle results in approximately a two-fold decrease in NOx to levels of less than 500 mg/MJ.

This effect was found to be not particularly sensitive to the number or size of outlet holes, and all three nozzles tested experimentally demonstrated ample decrease in NOx. Computational fluid dynamics (CFD) studies performed using the software ANSYS Fluent 16.0 and with geometry, variables and boundary conditions chosen to mimic the trials with precombustion chamber as described above confirm that the angle of the outlet holes may also be varied without unduly affecting the NOx emissions of the system. For example, a nozzle having 30° outlet hole angles (denoted 30°-6*9 mm by the same naming convention as above) was found by CFD simulation to lead to slightly lower NOx levels as compared to the nozzle 45°-6*9 mm. Likewise, a nozzle similar to 45°-6*9 mm, but provided with a further ring of 12 small cooling holes on the planar face of the nozzle) (θ=0° was also found by CFD simulation to lead to slightly lower NOx levels as compared to the nozzle 45°-6*9 mm without cooling holes.

Finally, trials were performed using the setup with precombustion chamber and standard or 45 deg—6*4 mm nozzles as described above, but with varying amounts of oxidant gas in order to investigate the effect of air-fuel equivalence ratio (λ, lambda) on NOx levels. It was found that with the standard nozzle and precombustion chamber, NOx emissions decreased more-or-less linearly with increasing lambda within the tested range of approx. 0.75<λ>1.2. However, with the angled nozzle and precombustion chamber, a parabolic distribution of NOx values was obtained, with a NOx minimum obtained at approximately λ=0.8-0.9. Thus, it is found that with an angled nozzle “rich” conditions in the precombustion chamber favour lower NOx emissions, whereas “lean” conditions are favoured by the standard nozzle.

1. An arrangement for heating a process gas of an iron ore pelletizing plant, the arrangement comprising:
a heating chamber comprising a process gas inlet, a process gas outlet, a wall extending from the process gas inlet to the process gas outlet, and a heating chamber port arranged in the wall at a point intermediate to the process gas inlet and the process gas outlet;
a burner assembly arranged to be connectible to a source of gaseous fuel and a to source of oxidant gas;
a precombustion chamber;
wherein the precombustion chamber comprises a burner port and a wall extending from the burner port to the heating chamber port;
wherein the burner assembly is arranged in the burner port of the precombustion chamber and wherein, when in operation, the burner assembly is arranged to introduce the gaseous fuel, the oxidant gas and/or combustion products thereof into the precombustion chamber; and
wherein the burner assembly comprises a fuel lance, wherein a nozzle of the fuel lance comprises a plurality of outlet holes, and wherein at least one of the plurality of outlet holes is arranged at an angle relative to a longitudinal axis of the fuel lance.

2. The arrangement according to claim 1, wherein each of the plurality of outlet holes is arranged at an angle relative to the longitudinal axis of the fuel lance.

3. The arrangement according to claim 2, wherein each of the plurality of outlet holes is arranged at an angle of 30° or greater relative to the longitudinal axis of the fuel lance.

4. The arrangement according to claim 1, wherein the nozzle comprises at least three outlet holes.

5. A pelletizing plant for iron ore, comprising an arrangement according to claim 1.

6. The pelletizing plant according to claim 5, wherein the pelletizing plant is a straight grate pelletizing plant, and wherein the process gas outlet is arranged in connection with a firing zone of the pelletizing plant.

7. The pelletizing plant according to claim 5, wherein the burner assembly is arranged in connection with a source of hydrogen gas as the source of gaseous fuel.

8. The pelletizing plant according to claim 5, wherein the burner assembly is arranged in connection with a recycled process gas stream as the source of oxidant gas.

9. A method for heating a process gas in a pelletizing plant according to claim 5, the method comprising the steps of:
supplying a process gas to the process gas inlet; and
supplying gaseous fuel and oxidant gas to the burner assembly, thereby introducing the gaseous fuel and oxidant gas into the precombustion chamber, where they react by combustion at least partially and are conveyed into the heating chamber, thereby heating the process gas.

10. The method according to claim 9, wherein the gaseous fuel consists essentially of hydrogen.

11. The method according to claim 9, wherein the process gas and/or the oxidant gas are independently composed essentially of recycled process gas streams.

12. The method according to claim 9, wherein the oxidant gas supplied to the burner assembly has a temperature greater than 300° C.

13. The method according to claim 9, wherein the process gas supplied to the process gas inlet has a temperature greater than 900° C.

14. The method according to claim 9, wherein oxidant gas and hydrogen gas are supplied to the burner assembly to achieve an air-fuel equivalence ratio (A) of from about greater than 0.6 to about less than 1.

15. The method according to claim 9, wherein oxidant gas is supplied to the burner assembly in order to achieve a volumetric flow ratio of process gas: oxidant gas of from about 5:1 to about 20:1.
